(19) United States
(12) Patent Application Publication
(10) Pub. No.: US 2017/0221016 A1
(43) Pub. Date: Aug. 3, 2017

(54) WORK MANAGING METHOD, WORK MANAGING APPARATUS, AND COMPUTER-READABLE RECORDING MEDIUM

(71) Applicant: FUJITSU LIMITED, Kawasaki-shi (JP)

(72) Inventors: Hiroshi SASAKI, Meguro (JP); Takashi SHIMADA, Shinagawa (JP); Hiroyuki TANI, Katsushika (JP)

(73) Assignee: FUJITSU LIMITED, Kawasaki-Shi (JP)

(21) Appl. No.: 15/490,147

(22) Filed: Apr. 18, 2017

Related U.S. Application Data
(63) Continuation of application No. PCT/JP2014/078835, filed on Oct. 29, 2014.

(51) Int. Cl. G06Q 10/00; G06Q 50/08

(52) U.S. Cl. CPC G06Q 10/20; G06Q 50/08

(57) ABSTRACT

A non-transitory computer-readable recording medium stores a work managing program that causes a computer to execute a process including: specifying, with reference to a memory that memorizes implementation plans of works for maintenances of a road and/or implementation plans of works for maintenances of objects buried in undergrounds of the road in association with places in which the respective works are to be implemented, a place for which both one of the works for maintenances of the road and one of the works for maintenances of objects are planned; and displaying implementation plans of the one of the works for maintenances of the road and the one of the works for maintenances of objects buried in undergrounds of the road corresponding to the specified place so that the implementation plans of both the works are able to be distinguished from implementation plans of other works.

### CROSS-REFERENCE TO RELATED APPLICATION

This application is a continuation application of International Application No. PCT/JP2014/078835, filed on Oct. 29, 2014 and designating the U.S., the entire contents of which are incorporated herein by reference.

### FIELD

The embodiment discussed herein is related to a work managing method, a work managing apparatus, and a computer-readable recording medium.

### BACKGROUND

Roads; gas pipes, water pipes, telephone cables, electric cables, which are buried under the roads; and the like are managed by an autonomous community such as a prefectural government and a municipality, and the autonomous community regularly checks states of target objects for managing, and, when there exists a deteriorated part, performs repairing on the deteriorated part.

For example, in repairing a road, there is performed an operation in which workers return asphalt having cracks and roughness to its original state. In repairing an object buried under a road, there is performed a work in which workers dig up the road, exchange thereafter various objects, restore the dug-up area, and re-construct the road.

Patent Document 1: Japanese Laid-open Patent Publication No. 2003-295757

Patent Document 2: Japanese Laid-open Patent Publication No. 2005-031824

Patent Document 3: Japanese Laid-open Patent Publication No. 2005-227913

Patent Document 4: Japanese Laid-open Patent Publication No. 2003-233646

Patent Document 5: Japanese Laid-open Patent Publication No. 9-209569

Patent Document 6: Japanese Laid-open Patent Publication No. 2002-041603

However, the aforementioned technology has a problem that a work period is elongated.

For example, each of the works for various objects is performed in accordance with the convenience of a company and the like having charge of the corresponding work, and is not coordinated with another work. Therefore, for example, a work for gas pipes, water pipes, and the like is performed in some cases after performing a work for a road so as to dig up the road that has been recently repaired, and thus a time period in which the road is not used may be elongated.

### SUMMARY

According to an aspect of the embodiments, a non-transitory computer-readable recording medium stores a work managing program that causes a computer to execute a process including: specifying, with reference to a memory that memorizes implementation plans of works for maintenances of a road and/or implementation plans of works for maintenances of objects buried in undergrounds of the road in association with places in which the respective works are to be implemented, a place for which both one of the works for maintenances of the road and one of the works for maintenances of objects are planned; and displaying implementation plans of the one of the works for maintenances of the road and the one of the works for maintenances of objects buried in undergrounds of the road corresponding to the specified place so that the implementation plans of both the works are able to be distinguished from implementation plans of other works.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a system according to a present embodiment;

FIG. 2 is a functional block diagram illustrating a configuration of a work managing apparatus according to the present embodiment;

FIG. 3 is a diagram illustrating a data structure example of deterioration information;

FIG. 4 is a diagram illustrating a data structure example of work information;

FIG. 5 is a diagram illustrating a data structure example of importance-degree source information;

FIG. 6 is a diagram illustrating a data structure example of an importance degree determining table;

FIG. 7 is a diagram illustrating a data structure example of a basic information table;

FIG. 8 is a diagram illustrating a data structure example of a summarized work method table;

FIG. 9 is a diagram illustrating a data structure example of a work method/schedule table;

FIG. 10 is a diagram illustrating a data structure example of a simulation result table;

FIG. 11 is a diagram illustrating one example of matching;

FIG. 12 is a diagram illustrating one example of a display screen that is displayed on a terminal device by a display controller;

FIG. 13 is a diagram illustrating processes of a change processing unit;

FIG. 14 is a flowchart illustrating a processing procedure of the work managing apparatus according to the present embodiment;

FIG. 15 is a diagram illustrating effects of the work managing apparatus according to the present embodiment; and

FIG. 16 is a diagram illustrating one example of a computer that executes a work managing program.

### DESCRIPTION OF EMBODIMENT

Preferred embodiments will be explained with reference to accompanying drawings. The disclosed technology is not limited to the embodiment described below.

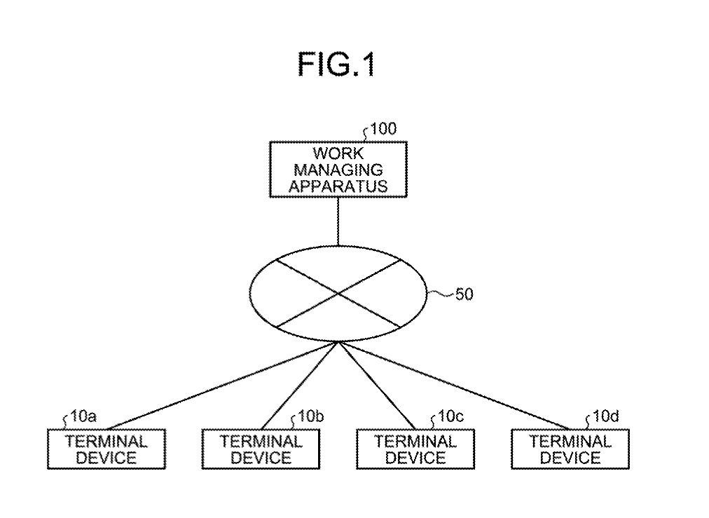

A configuration example of a system according to a present embodiment will be explained. FIG. 1 is a diagram illustrating a configuration of a system according to the present embodiment. As illustrated in FIG. 1, this system includes a work managing apparatus 100 and terminal devices 10a, 10b, 10c, and 10d. In the following explanation, the terminal devices 10a to 10d may be collectively referred to as terminal devices 10 as appropriate.

Each of the terminal devices 10 and the work managing apparatus 100 are connected with each other through a network 50. The network 50 corresponds to a Local Area Network (LAN), the Internet, etc.

Each of the terminal devices 10 is a terminal device that is used by a staff of an autonomous community and a worker of a company that takes on works. For example, a staff of an autonomous community operates the terminal device 10 to inform the work managing apparatus 100 of deterioration information, importance-degree source information, budget information, etc. The deterioration information includes information that indicates to what extents roads are deteriorated. Objects buried in undergrounds of a road correspond to, for example, gas pipes, water pipes, telephone cables, electric cables and the like. The importance-degree source information includes information that is used for computing importance degrees of sections. Detailed explanation on the deterioration information and the importance-degree source information will be mentioned later. The budget information indicates budgets of autonomous communities, which are spent on works.

A worker of a company that takes on a work operates the terminal device 10 to inform the work managing apparatus of work information. The work information includes information on a kind of the work, planned date when the work is implemented, etc. The detailed explanation on the work information will be mentioned later.

The work managing apparatus 100 is a device that performs a presentation that encourages, when a work for a road and a work performed by digging up the road are planned in the same section and implementation plans of the respective works differ from each other, a change of the implementation plans of the works based on information sent from the terminal devices 10.

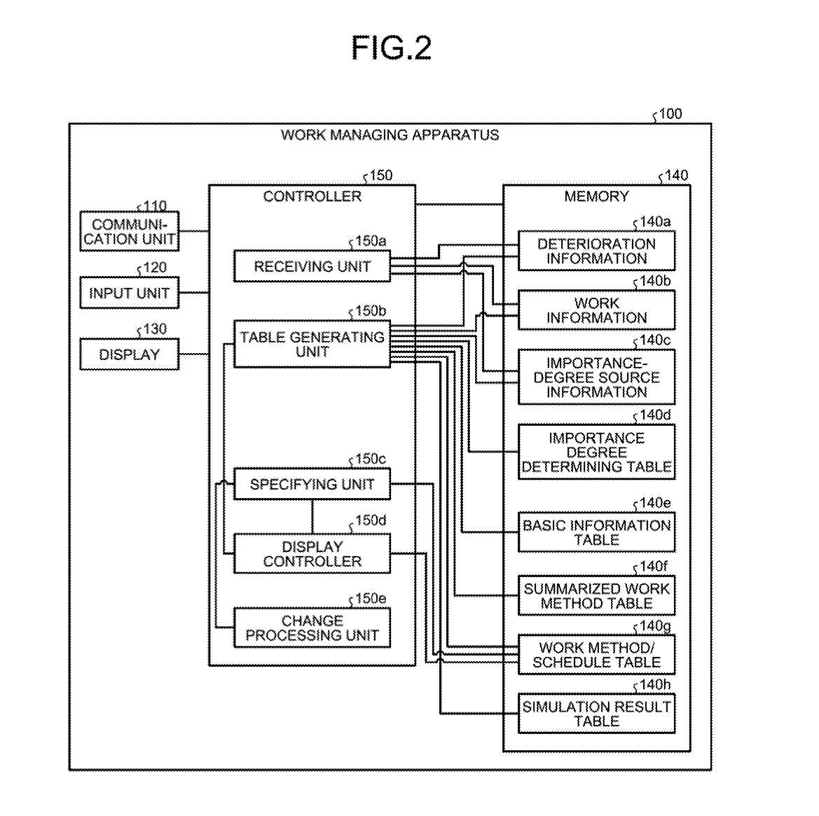

A configuration example of the work managing apparatus 100 illustrated in FIG. 1 will be explained. FIG. 2 is a functional block diagram illustrating a configuration of the work managing apparatus according to the present embodiment. As illustrated in FIG. 2, this work managing apparatus 100 includes a communication unit 110, an input unit 120, a display 130, a memory 140, and a controller 150.

The communication unit 110 is a process unit that performs data communication with the terminal devices 10 through the network 50. For example, the communication unit 110 corresponds to a communication device, etc. The controller 150 to be mentioned later exchanges data with the terminal devices 10 through the communication unit 110.

The input unit 120 is an input device that inputs various kinds of information to the work managing apparatus 100. For example, the input unit 120 corresponds to a keyboard, a mouse, a touch panel, etc.

The display 130 is a display device that displays various data output from the controller 150. For example, the display 130 corresponds to a liquid crystal display, a touch panel, etc.

The memory 140 includes deterioration information 140a, work information 140b, importance-degree source information 140c, and an importance degree determining table 140d. The memory 140 further includes a basic information table 140e, a summarized work method table 140f, a work method/schedule table 140g, and a simulation result table 140h. The memory 140 corresponds to a memory device that is, for example, a semiconductor memory element such as a Random Access Memory (RAM), a Read Only Memory (ROM), and a Flash Memory.

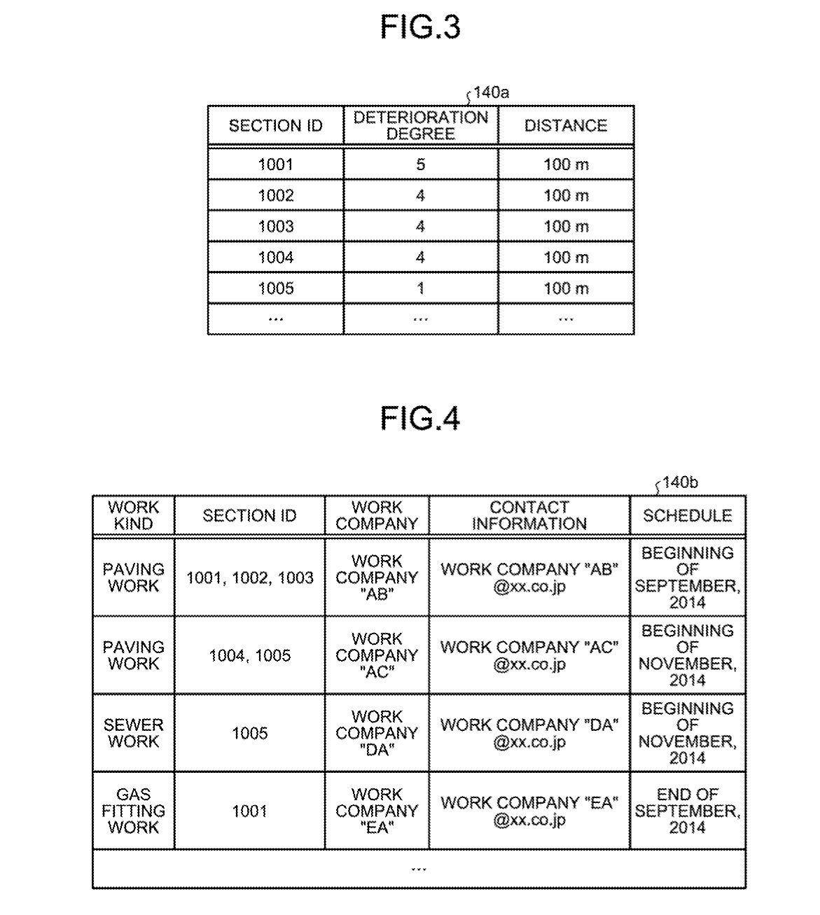

The deterioration information 140a is information that indicates to what extent a road is deteriorated for each of sections. FIG. 3 is a diagram illustrating a data structure example of the deterioration information. As illustrated in FIG. 3, this deterioration information associates a section IDentification (ID), a deterioration degree, and a distance with one another. The section ID is information that uniquely specifies a section. The deterioration degree indicates to what extent a road or an object buried in an underground of the road is deteriorated, and the deterioration degree is larger as a numerical value thereof is larger. The distance indicates a distance of a section indicated by a section ID.

The work information 140b is information that indicates kinds of works and planned dates when the works are implemented, etc. FIG. 4 is a diagram illustrating a data structure example of the work information. As illustrated in FIG. 4, this work information 140b associates a work kind, a section ID, a work company, contact information, and a schedule with one another.

The work kind illustrated in FIG. 4 is information on kinds of works. The work kind includes, for example, a paving work, a waterworks work, a sewer work, an electric work, a telephone communication work, a gas fitting work, and the like. The section ID is information that uniquely identifies a section. In the work information 140b, when there exist two or more sections to be work targets, two or more section IDs are set, respectively. The work company is information that indicates companies that take on respective works. The contact information indicates contact information of the work company. The schedule indicates planned dates when the respective works are implemented.

For example, a record of the first row illustrated in FIG. 4 indicates the fact that “paving work” is planned at “beginning of September, 2014” in sections identified by section IDs “1001, 1002, and 1003”. Moreover, this record indicates the fact that a work company that performs this paving work is “work company AB” and contact information of this work company AB is “work company AB@xx.co.jp”.

In the present embodiment, the expression of “beginning”, “middle”, and “end” is used for a schedule as an example, not limited thereto, the schedule may be specified by using date. The “beginning” corresponds to the 1st to the 10th of a month. The “middle” corresponds to the 11th to the 20th of a month. The “end” corresponds to the 21th to the last day of a month. Moreover, days corresponding to each of “beginning”, “middle”, and “end” may be appropriately set by an administrator.

The importance-degree source information 140c includes information used for computing importance degrees of sections. FIG. 5 is a diagram illustrating a data structure example of the importance-degree source information. As illustrated in FIG. 5, this importance-degree source information 140c associates a section ID, a traffic amount of vehicles, counts of sudden brakes, and a distance to the nearest school with one another. The example illustrated in FIG. 5 is merely an example, not limited to a distance to the nearest school, for example, a distance to the nearest school, hospital, or another important facility may be employed.

In FIG. 5, the section ID is information that uniquely identifies a section. The traffic amount of vehicles indicates, for example, counts of vehicles that go through a section identified by the section ID, per month. The counts of sudden brakes indicate counts of sudden brakes, in the past one year, performed by vehicles in a section identified by the section ID. The distance to the nearest school indicates a distance from a section identified by the section ID to the nearest school.

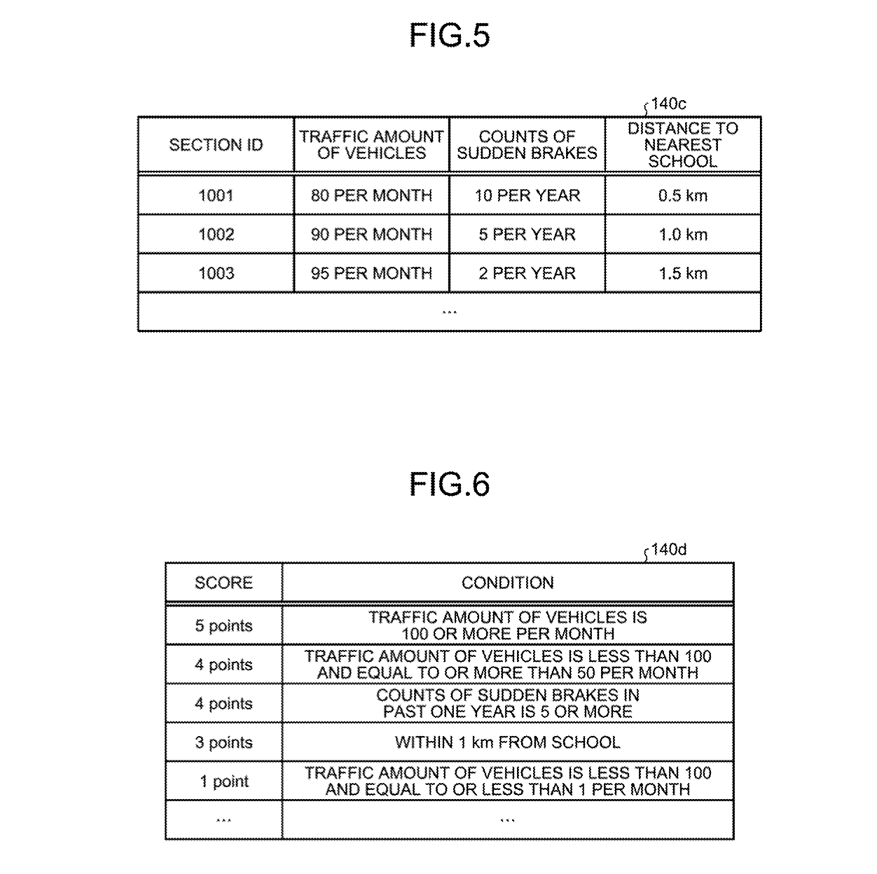

The importance degree determining table 140d is a table that is used when an importance degree is determined. FIG. 6 is a diagram illustrating a data structure example of the importance degree determining table. As illustrated in FIG. 6, the importance degree determining table 140d associates a score and a condition with each other. The score is a score given, when a condition is satisfied, to a section that satisfies this condition. An importance degree corresponding to the score is assigned to the section. The condition defines contents of the condition.

For example, when a traffic amount of vehicles of some section is one hundred or more per month, a score “5 points” is given to this section. In a section that satisfies two or more conditions, scores corresponding to the respective conditions are added. For example, when a traffic amount of vehicles of some section is one hundred or more per month and counts of sudden brakes thereof in the past one year is five or more, a score “nine points” is given to this section. Importance degrees are assigned to the respective sections in accordance with the scores thereof. A process for assigning the importance degree will be explained later.

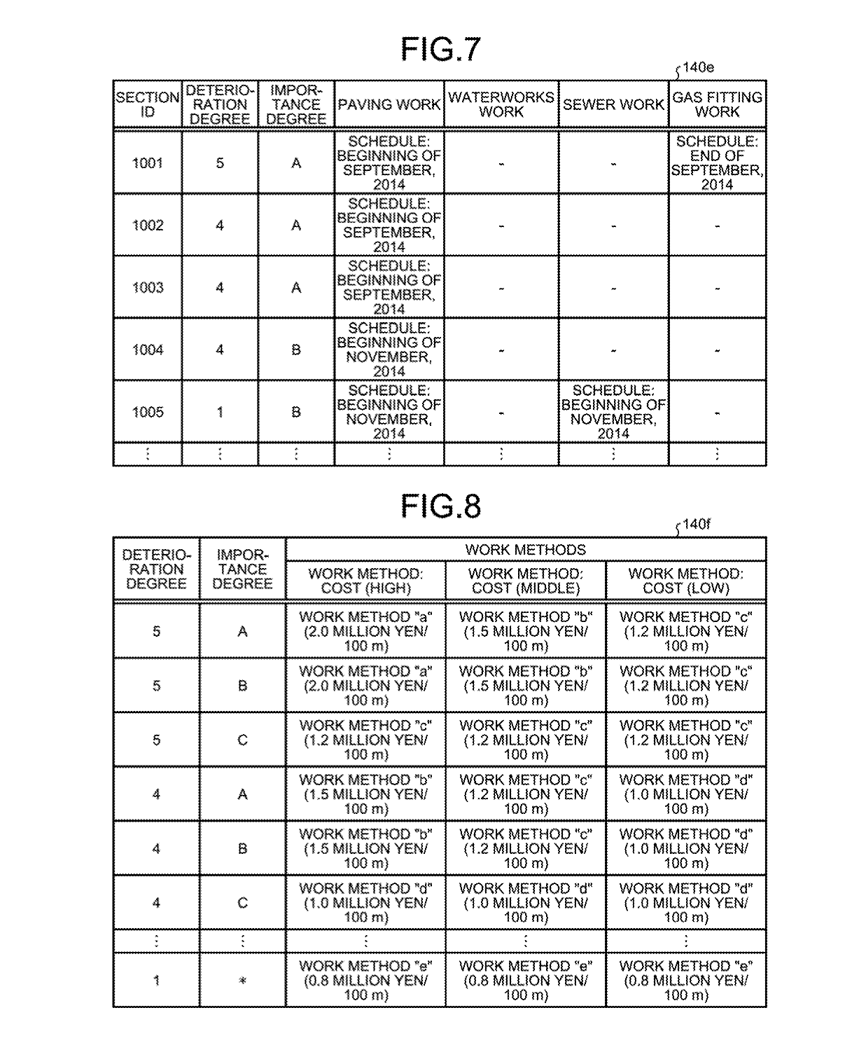

The basic information table 140e is information that collects a deterioration degree, an importance degree, and schedules corresponding one-to-one to work kinds, for each section ID. FIG. 7 is a diagram illustrating a data structure example of the basic information table. As illustrated in FIG. 7, this basic information table 140e associates a section ID, a deterioration degree, an importance degree, and schedules corresponding one-to-one to work kinds with one another. The section ID, the deterioration degree, and the importance degree are similar to those in the aforementioned explanation. The schedules corresponding one-to-one to work kinds are planned implementation dates when the works are implemented.

For example, the deterioration degree of a section of a section ID “1001” is “5”, and the importance degree thereof is “A”. For the section of the section ID “1001”, “paving work” is planned, and the schedule thereof is “beginning of September, 2014”. Moreover, for the section of the section ID “1001”, “gas fitting work” is planned, and the schedule thereof is “end of September, 2014”.

The summarized work method table 140f is information that defines selectable work methods in accordance with a deterioration degree and an importance degree. FIG. 8 is a diagram illustrating a data structure example of the summarized work method table. As illustrated in FIG. 8, this summarized work method table 140f associates a deterioration degree, an importance degree, and work methods with one another. The work methods includes “work method: cost (high)”, “work method: cost (middle)”, and “work method: cost (low)”. A cost per 100 m is defined for the work method. For example, a cost of a work method “a” per 100 m is two million yen.

For example, when a deterioration degree of one section is “5” and an importance degree thereof is “A”, a work method is selected among from selectable work methods of work methods “a”, “b”, and “c”.

The work method/schedule table 140g is information that sets selectable work methods for each section ID. The work method/schedule table 140g includes information of whether or not, when works having different work kinds are planned for the same section ID, planned implementation dates of the respective works match with each other.

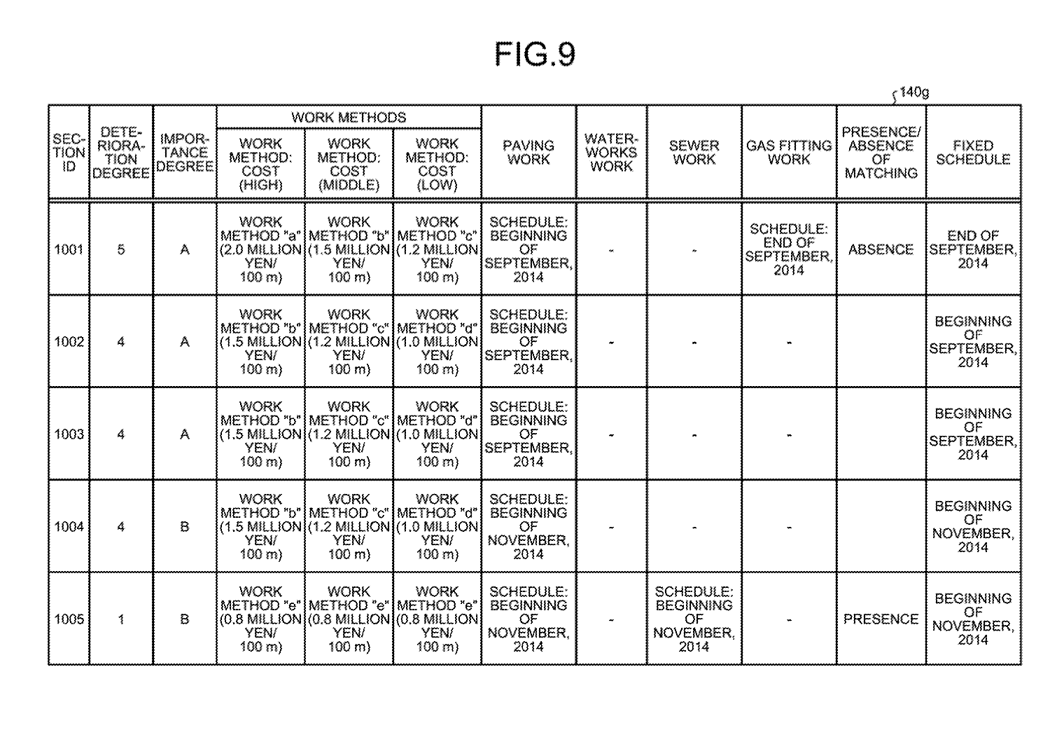

FIG. 9 is a diagram illustrating a data structure example of the work method/schedule table. As illustrated in FIG. 9, the work method/schedule table 140g associates a section ID, a deterioration degree, an importance degree, work methods, schedules of respective work kinds, a presence/absence of matching, and a fixed schedule with one another. The section ID, the deterioration degree, the importance degree, the work methods, and the schedules of respective work kinds are similar to those in the aforementioned explanation.

The presence/absence of matching indicates whether or not, when works having different work kinds are planned for the same section ID, planned implementation dates of the respective works match with each other. When planned implementation dates of the works match or partially overlap with each other, “presence” is set. When planned implementation dates of the works do not match with each other and there exists no overlapped time period therebetween, “absence” is set. A presence/absence of matching is set to be blank for a section ID of a section where two or more works are not implemented.

For example, for the section ID “1001”, a schedule of a paving work is “beginning of September, 2014” and that of a gas fitting work is “end of September, 2014”, and thus planned implementation dates of the respective works do not match with each other. Therefore, a presence/absence of matching for the section ID “1001” becomes “absence”.

For a section ID “1005”, a schedule of a paving work is “beginning of November, 2014” and that of a sewer work is “beginning of November, 2014”, and thus planned implementation dates of the respective works match with each other. Therefore, a presence/absence of matching for the section ID “1005” becomes “presence”.

A fixed schedule is a planned implementation date of the works, which is finally decided by a worker. Herein, a single schedule is illustrated for a section ID as an example, a schedule may be set for each work kind.

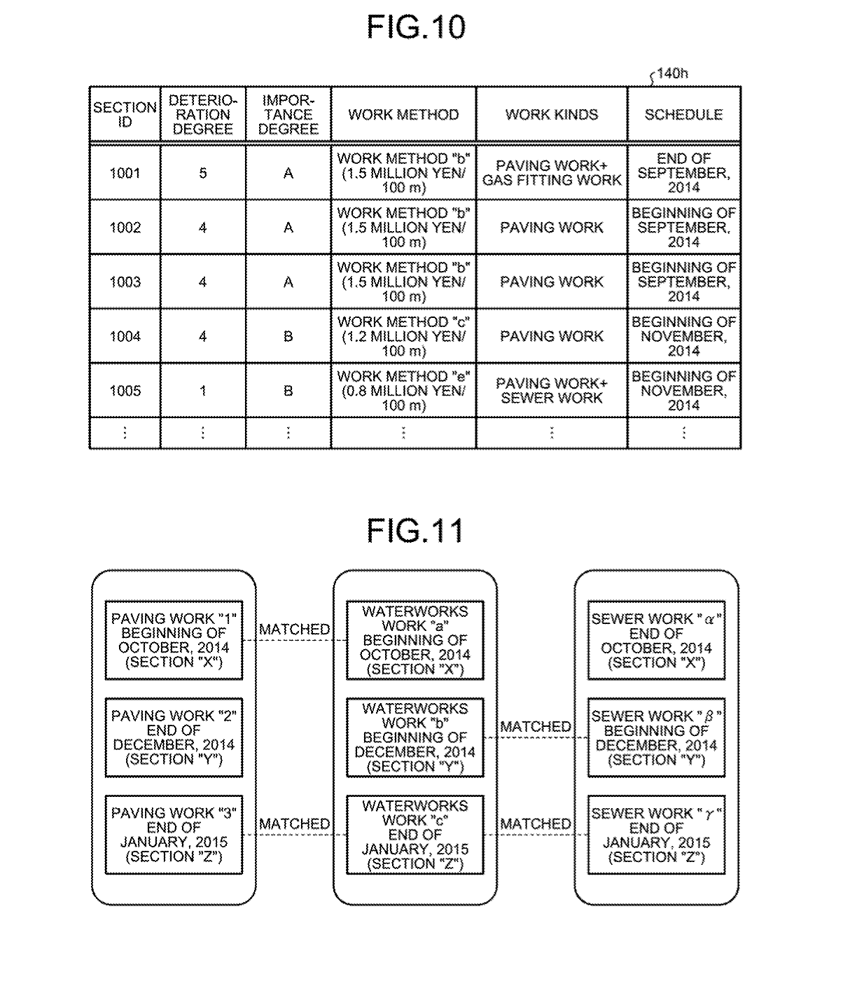

The simulation result table 140h is information that indicates a work method, work kinds, and a schedule, which are decided for each section ID. FIG. 10 is a diagram illustrating a data structure example of the simulation result table. As illustrated in FIG. 10, this simulation result table 140h associates a section ID, a deterioration degree, an importance degree, a work method, work kinds, and a schedule with one another.

The section ID, the deterioration degree, and the importance degree illustrated in FIG. 10 are similar to those in the aforementioned explanation. The work method indicates a work method selected by a worker among from the selectable work methods included in the work method/schedule table 140g. The work kinds indicate one or more kinds of works that are planned in a section corresponding to a section ID. The schedule is a planned implementation date of one or more works planned in the section corresponding to the section ID. Herein a single schedule is illustrated for a section ID as an example, a schedule may be set for each work kind.

The explanation there of is omitted in FIG. 10, information on an total amount needed for all of the works may be stored in the simulation result table 140h.

By returning to the explanation of FIG. 2, the controller 150 includes a receiving unit 150a, a table generating unit 150b, a specifying unit 150c, a display controller 150d, and a change processing unit 150e. The controller 150 corresponds to an integrated device such as an Application Specific Integrated Circuit (ASIC) and a Field Programmable Gate Array (FPGA). The controller 150 corresponds to an electronic circuit such as a Central Processing Unit (CPU) and a Micro Processing Unit (MPU).

The receiving unit 150a is a process unit that receives the deterioration information 140a, the work information 140b, and the importance-degree source information 140c from the terminal device 10. The receiving unit 150a stores the deterioration information 140a, the work information 140b, and the importance-degree source information 140c in the memory 140. When receiving budget information from the terminal device 10, the receiving unit 150a stores the budget information in the memory 140. Herein, illustration of the budget information is omitted.

The table generating unit 150b is a process unit that generates the basic information table 140e, the work method/schedule table 140g, and the simulation result table 140h.

One example of a process of the table generating unit 150b for generating the basic information table 140e will be explained. The table generating unit 150b compares a section ID, the deterioration information 140a, and the work information 140b with one another, and specifies a deterioration degree corresponding to the section ID and a schedule of each work kind. The table generating unit 150b registers the deterioration degree corresponding to the specified section ID and the specified schedule of each work kind in the basic information table 140e.

One example of a process of the table generating unit 150b for computing an importance degree will be explained. The table generating unit 150b compares a section ID and the importance-degree source information 140c with each other, and specifies a traffic amount of vehicles corresponding to the section ID, counts of sudden brakes, and a distance to the nearest school. The table generating unit 150b compares the specified traffic amount of vehicles, the specified counts of sudden brakes, and the specified distance to the nearest school with the importance degree determining table 140d, and determines whether or not each condition of the importance degree determining table 140d is satisfied. The table generating unit 150b totalizes scores of records that satisfies conditions among conditions of the importance degree determining table 140d so as to compute a score corresponding to the section ID.

For example, when a traffic amount of vehicles corresponding to some section ID is one hundred or more per month and counts of sudden brakes in the past one year is five or more, a score of the section ID becomes “nine points”. The table generating unit 150b compares the score of the section ID with two or more thresholds so as to determine an importance degree. For example, when the score of the section ID is a first threshold or more, the table generating unit 150b determines the importance degree of this section ID to be “A”. When the score of the section ID is less than the first threshold and equal to or more than a second threshold, the table generating unit 150b determines the importance degree of this section ID to be “B”. When the score of the section ID is less than the second threshold and equal to or more than a third threshold, the table generating unit 150b determines the importance degree of this section ID to be “C”.

Magnitude relation between first to third thresholds is “first threshold >second threshold >third threshold”. The first to third thresholds are values that are previously set by an administrator of the work managing apparatus 100. The table generating unit 150b registers the determined importance degree of the section ID in the basic information table 140e.

The table generating unit 150b executes the aforementioned process on each section ID to generate the basic information table 140e. When any of the deterioration information 140a, the work information 140b, the importance-degree source information 140c, and the importance degree determining table 140d is updated, the table generating unit 150b may execute the aforementioned process again to update the tables 140e, 140g, and 140h.

Next, one example of a process of the table generating unit 150b for generating the work method/schedule table 140g will be explained. The table generating unit 150b registers, in the work method/schedule table 140g, information on a section ID, a deterioration degree, an importance degree, and a schedule of each work kind, which are stored in the basic information table 140e.

The table generating unit 150b compares the summarized work method table 140f with a combination of a deterioration degree and an importance degree, corresponding to a section ID, of the work method/schedule table 140g, and specifies selectable work methods corresponding to the combination of the deterioration degree and the importance degree. For example, a deterioration degree of the section ID “1001” is “5” and an importance degree thereof is “A”, as illustrated in FIG. 8, selectable work methods corresponding to the section ID “1001” are “work methods a, b, and c”. The table generating unit 150b registers, in the work method/schedule table 140g, information on the specified work methods in association with the section ID.

Information on a presence/absence of matching of the work method/schedule table 140g is specified by the specifying unit 150c to be mentioned later. Information on a fixed schedule of the work method/schedule table 140g is set by a staff of an autonomous community or a worker, which operates the terminal device 10. The fixed schedule information may be automatically set by the change processing unit 150e to be mentioned later.

Next, one example of a process of the table generating unit 150b for generating the simulation result table 140h will be explained. When information of the work method/schedule table 140g is fixed, the table generating unit 150b generates the simulation result table 140h based on this work method/schedule table 140g. For example, information on whether or not the information of the work method/schedule table 140g is fixed is assumed to be reported from the terminal device 10.

The table generating unit 150b registers a deterioration degree, an importance degree, and a fixed schedule corresponding to a section ID, which are stored in the work method/schedule table 140g, in a deterioration degree, an importance degree, and a schedule of the simulation result table 140h, respectively. The table generating unit 150b registers, in a work method of the simulation result table 140h, a work method selected by a worker among from the work methods stored in the work method/schedule table 140g. The table generating unit 150b registers the work kinds stored in the work method/schedule table 140g in work kinds of the simulation result table 140h.

The table generating unit 150b may compute a total amount needed for all of the works based on information registered in the simulation result table 140h, and may register the total amount in the simulation result table 140h. For example, the table generating unit 150b specifies a distance of a section of a section ID with reference to the deterioration information 140a. The table generating unit 150b computes costs by the section based on the specified distances and the costs per 100 m corresponding to the respective work methods, and totalizes the costs of the sections to compute the total amount needed for all of the works.

Herein, when computing the total amount, the table generating unit 150b may compute a cost of each work. When two or more works are planned to be implemented at the same section and the same schedule, costs of the works may be divided into halves, or division of costs of the works may be adjusted in accordance with work kinds. For example, a cost of a work is higher as the work is performed at a deeper position, because the depth of a road to be dug up is deeper as the work is performed at a deeper position. Therefore, the table generating unit 150b may adjust the division so that a cost of a work performed at a deep position is larger than that performed at a shallow position.

The specifying unit 150c is a process unit that specifies, based on the work method/schedule table 140g, a section for which both a work for a maintenance of a road and the a work for a maintenance of an object buried in an underground of the road are planned. The specifying unit 150c outputs a section ID of the specified section to the display controller 150d and the change processing unit 150e.

Herein, the work for the maintenance of the road corresponds to, for example, a paving work of a road. The work for the maintenance of the object buried in the underground of the road corresponds to, for example, a waterworks work, a sewer work, a gas fitting work, a telephone cable work, an electric cable work.

When two or more kinds of works are planned for the same section, the specifying unit 150c determines whether or not planned implementation dates of the works match with each other based on the work method/schedule table 140g. When the planned implementation dates of the works match or partially overlap with each other, the specifying unit 150c sets “presence” for the presence/absence of matching of the work method/schedule table 140g. When the planned implementation dates of the works do not match with each other and there exists no overlapped time period, the specifying unit 150c sets “absence” for the presence/absence of matching of the work method/schedule table 140g.

FIG. 11 is a diagram illustrating one example of matching. For example, in a section X, a schedule of a paving work 1 and that of a waterworks work “a” match with each other, however, neither of them matches with a sewer work α. In a section Y, a schedule of a waterworks work “b” and that of a sewer work β, match with each other, however, neither of them matches with a paving work 2. In a section Z, schedules of a paving work 3, a waterworks work “c”, and a sewer work γ match with one another. Implementation of the matched works at the same time can prevent waste in the works.

The display controller 150d is a process unit that informs the terminal device 10 of information on the work method/schedule table 140g, and causes the terminal device 10 to display the information on the work method/schedule table 140g. The display controller 150d causes the terminal device 10 to display, for a section for which two or more works are planned, planned implementation dates of the works so that the dates can be identified (distinguished), based on a section ID acquired from the specifying unit 150c. The display controller 150d may highlight, on a map, the section for which two or more works are planned.

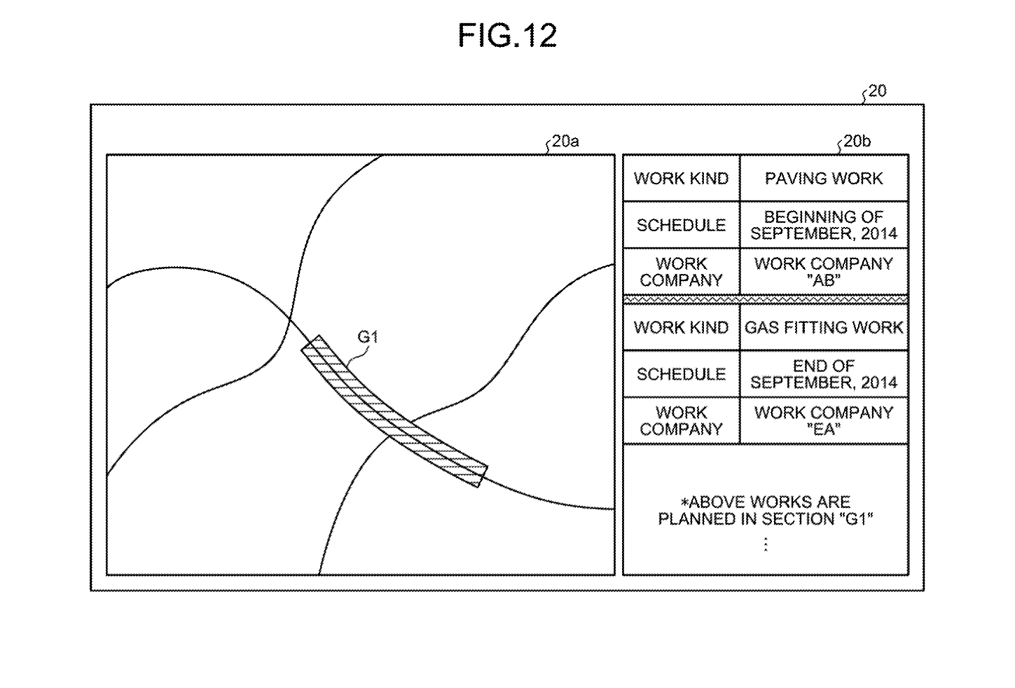

FIG. 12 is a diagram illustrating one example of a display screen that is displayed on the terminal device by the display controller. A display screen 20 includes a map screen 20a and a schedule screen 20b. The display controller 150d highlights, in the map screen 20a, a section G1 for which two or more works are planned. For example, the display controller 150d specifies a position, on a map, of a section for which two or more works are planned based on a table in which section IDs and positions on the map are associate with each other and a section ID acquired from the specifying unit 150c. Map information is assumed to be stored in the memory 140.

In FIG. 12, the display controller 150d controls to display, on the schedule screen 20b, work kinds, schedules, and work companies of respective works to be performed in the same section. In the example illustrated in FIG. 12, there are displayed “paving work” as a work kind, “beginning of September, 2014” as a schedule, and “work company AB” as a work company; and “gas fitting work” as a work kind, “end of September, 2014” as a schedule, and “work company EA” as a work company.

For example, a worker of the work company AB and that of the work company EA, which refer to contents illustrated in FIG. 12 on the terminal devices 10 can have a discussion to adjust the schedule. For example, when the worker of the work company AB changes the schedule from “beginning of September” to “end of September”, the works can be implemented together. For example, when the schedule is finally fixed after the discussion, each worker informs the work managing apparatus 100 of information of the corresponding fixed schedule. The display controller 150 registers the information of the fixed schedule in a fixed schedule of the work method/schedule table 140g.

The display controller 150d informs the terminal device 10 of information of the work method/schedule table 140g to cause the terminal device 10 to display the information of the work method/schedule table 140g, and requests to select any one of selectable work methods. A worker operates the terminal device 10 to select one the selectable work methods, and the display controller 150d receives the selected work method. When the work method is selected, the display controller 150d may compute a cost of a work by the selected work method, and may display the cost on the terminal device 10.

When the table generating unit 150b generates the simulation result table 140h, the display controller 150d informs the terminal device 10 of information of the simulation result table 140h so as to cause the terminal device 10 to display the information.

By returning to the explanation of FIG. 2, the change processing unit 150e executes the following process with respect to a section for which two or more works are planned based on a section ID acquired from the specifying unit 150c. The change processing unit 150e performs a presentation that encourages a change of at least one of implementation plans of works among an implementation plan of a work for a maintenance of a road and that of a work for a maintenance of an object buried in an underground of the road. Or, the change processing unit 150e changes at least one of implementation plans of works among an implementation plan of a work for a maintenance of a road and that of a work for a maintenance of an object buried in an underground of the road.

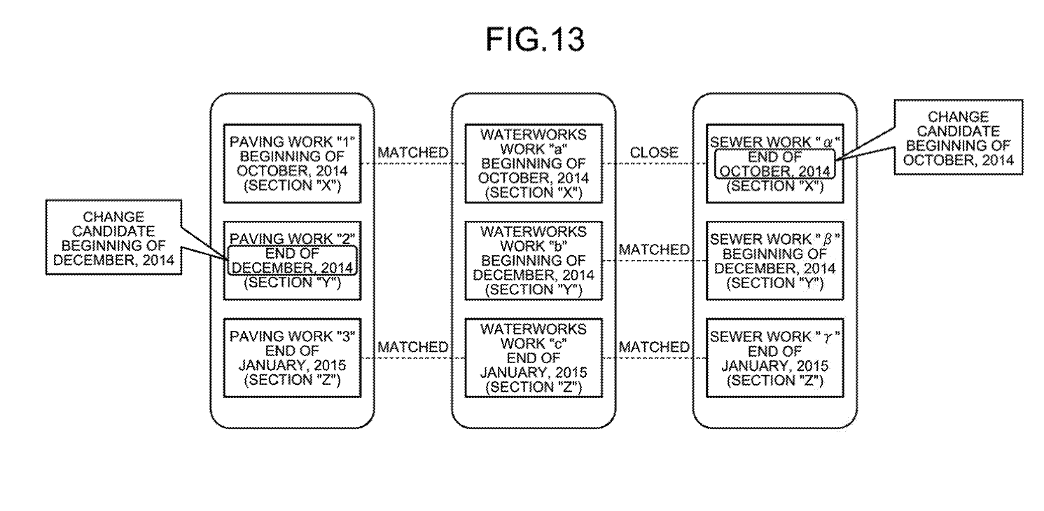

FIG. 13 is a diagram illustrating processes of the change processing unit. In the example illustrated in FIG. 13, with respect to the section X, a schedule of the paving work 1 and that of a waterworks work “a” match with each other, however, neither of them matches with a schedule of a sewer work a. For example, when the schedule of the sewer work a is matched with the schedules of the paving work 1 and the waterworks work “a”, an overlap of digging-up operations of a road can be prevented, and thus a time period for the works can be shortened. The change processing unit 150e causes the terminal device 10 to perform a presentation that encourages a change of the schedule of the sewer work a from “end of October, 2014” to “beginning of October, 2014”. When receiving information that indicates the fact that the change is accepted from the terminal device 10, the change processing unit 150e accesses the work information 140b, and changes the schedule of the sewer work a of the section X into “beginning of October, 2014”.

With respect to the section Y, a schedule of a waterworks work “b” and that of a sewer work β match with each other, however, neither of them matches with a schedule of the paving work 2. For example, when the schedule of the paving work 2 is matched with the schedules of the waterworks work “b” and the sewer work R, an overlap of digging-up operations of a road can be prevented, and thus a work period can be shortened. The change processing unit 150e causes the terminal device 10 to perform a presentation that encourages a change of the schedule of the paving work 2 from “end of December, 2014” to “beginning of December, 2014”. When receiving information that indicates the fact that the change is accepted from the terminal device 10, the change processing unit 150e accesses the work information 140b, and changes the schedule of the paving work 2 of the section Y into “beginning of December, 2014”.

Herein, one example of a process of the change processing unit 150e for determining a work whose schedule is to be changed and that for specifying the changed schedule will be explained. The change processing unit 150e specifies, in the same section ID, a combination of different works whose schedules do not match with each other and whose interval days between the schedules are less than predetermined days, with reference to the work method/schedule table 140g. The change processing unit 150e specifies a schedule of one of the combination of the specified works as a changed schedule of the other work.

The change processing unit 150e may set the priority order for each work kind, and may specify a work whose schedule is to be changed and a changed schedule so that a schedule of a work whose priority order is low is matched to that whose priority order is high. For example, magnitude relation of the priority order is assumed to be “gas pipe work >sewer work >waterworks work >paving work”. The magnitude relation of the priority order may be appropriately changed by an administrator of the work managing apparatus 100. For example, the priority order may be set higher as a position of a work target is deeper.

Moreover, when changing a schedule, the change processing unit 150e may set a changed schedule so that the changed schedule is within a specific time period. For example, when operating the terminal device 10 to send the work information 140b to the work managing apparatus 100, a worker is assumed to specify a schedule along with a specific time period that tolerates a change of the schedule. For example, a schedule of some paving work is assumed to be specified as “beginning of September, 2014” and a specific time period thereof is assumed to be specified as “1st to the last day of September”. When changing a schedule of this paving work, the change processing unit 150e changes the schedule so that the schedule is included in the specific time period of “1st to the last day of September”.

When changing a schedule of a work, the change processing unit 150e may inform the terminal device 10 of an order destination of information on the changed schedule of the work.

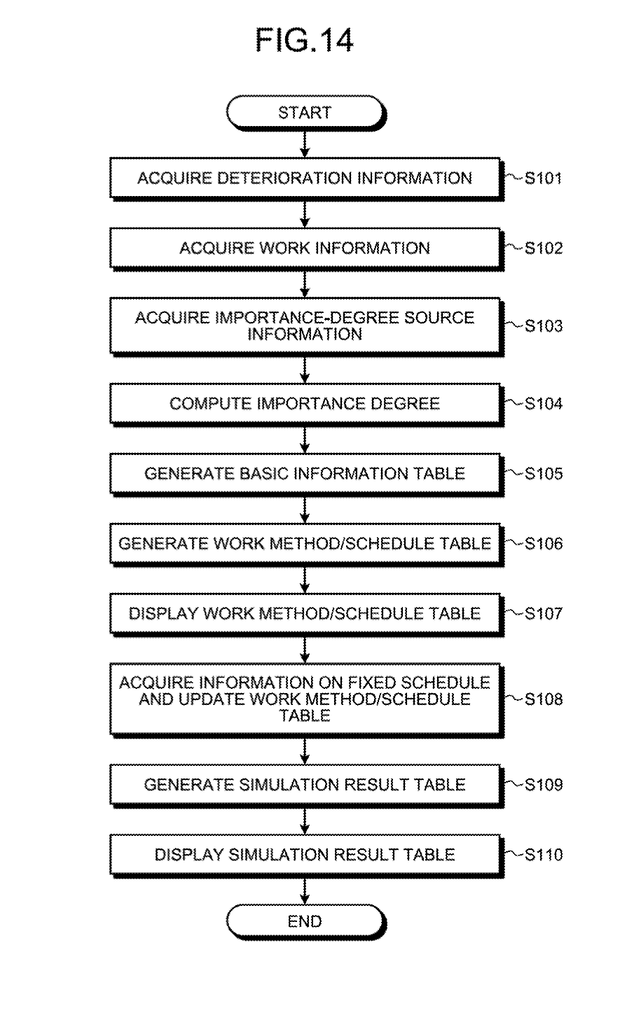

Next, one example of a processing procedure of the work managing apparatus 100 according to the present embodiment will be explained. FIG. 14 is a flowchart illustrating a processing procedure of the work managing apparatus according to the present embodiment. As illustrated in FIG. 14, the receiving unit 150a of the work managing apparatus 100 acquires the deterioration information 140a, and stores the acquired deterioration information 140a in the memory 140 (Step S101). The receiving unit 150a acquires the work information 140b, and stores the acquired work information 140b in the memory 140 (Step S102). The receiving unit 150a acquires the importance-degree source information 140c, and stores the acquired importance-degree source information 140c in the memory 140 (Step S103).

The table generating unit 150b of the work managing apparatus 100 computes an importance degree of each section ID based on the importance-degree source information 140c (Step S104). The table generating unit 150b generates the basic information table 140e (Step S105). The table generating unit 150b generates the work method/schedule table 140g (Step S106), and the display controller 150d of the work managing apparatus 100 causes the terminal device 10 to display the work method/schedule table 140g (Step S107). In Step S107, the change processing unit 150e of the work managing apparatus 100 may execute, in addition to a process of the display controller 150d, a process for performing a presentation that encourages a change of an implementation plan of a work among works having different schedules to be performed in the same section, or updating the implementation plan.

The display controller 150d acquires information on the fixed schedule from the terminal device 10, and updates the work method/schedule table 140g (Step S108). The table generating unit 150b generates the simulation result table 140h based on the work method/schedule table 140g (Step S109). The display controller 150d causes the terminal device 10 to display the simulation result table 140h (Step S110).

Next, effects of the work managing apparatus 100 according to the present embodiment will be explained. When a work for a maintenance of a road and a work for a maintenance of an object buried under the road are planned in the same section, and planned implementation dates of the respective works differ from each other, the work managing apparatus 100 performs a presentation that encourages a change of the implementation plan of the work. Thus, a comprehensive time period for the work can be shortened.

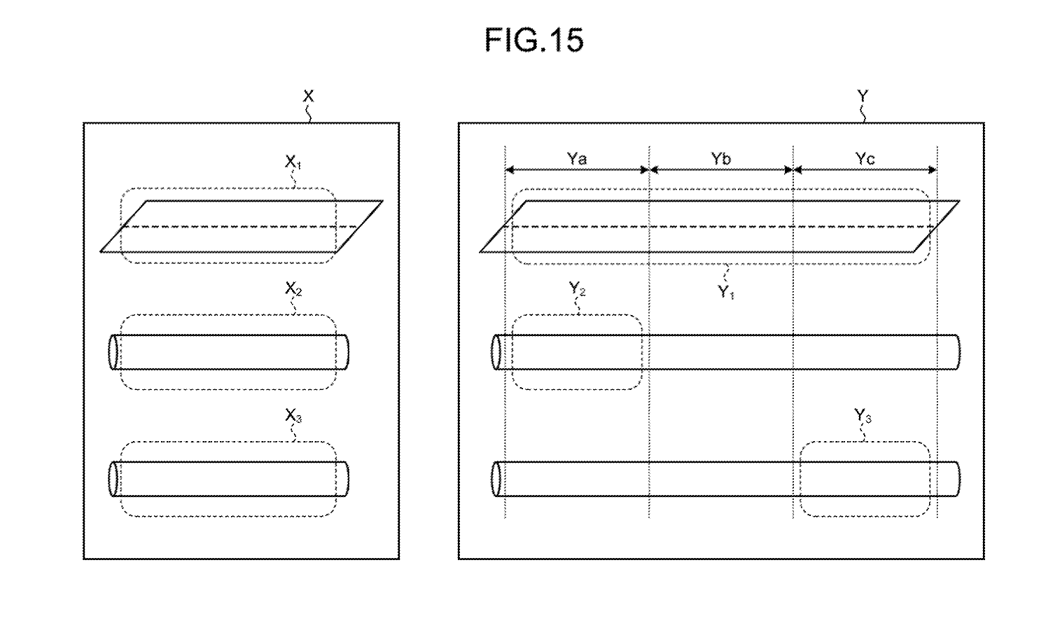

FIG. 15 is a diagram illustrating effects of the work managing apparatus according to the present embodiment. For example, a paving work X₁, an electric work X₂, and a sewer work X₃ are planned in the section X. When the schedules of the works X₁ to X₃ having different depths and to be performed in the same section are matched, repeated digging-up operations and the like can be suppressed, and thus a work period can be shortened.

When two or more kinds of works are planned in bordering sections, the work managing apparatus 100 may integrate the bordering sections, and may execute the aforementioned process. A paving work Y₁, an electric work Y₂, and a sewer work Y₃ are assumed to be scheduled in the section Y. The section Y includes sections Ya, Yb, and Yc. Sections of the paving work Y₁ is the sections Ya, Yb, and Yc. A section of the electric work Y₂ is the section Ya. A section of a sewer work Y₃ is the section Yc. For example, in a case where sections of works differ from each other, when the sections are integrated and schedules of the works are changed, repeated digging-up operations and the like can be suppressed, and thus a work period can be shortened.

When the paving work X₁, the electric work X₂, and the sewer work X₃ are planned in the section X, a work is performed more preferentially as the work is performed at a deeper position. Thus, the work managing apparatus 100 may further fragment and set schedules in accordance with depths of the respective works. For example, when the paving work X₁, the electric work X₂, and the sewer work X₃ are planned at the beginning of September, the work managing apparatus 100 sets a planned implementation date earlier as a position of the work is deeper. For example, the work managing apparatus 100 sets the schedule of the sewer work X₃ to be from 1st to 3rd of September, that of the electric work X₂ to be from 4-th to 6-th of September, and that of the paving work X₁ to be from 7-th to 10-th of September.

The work managing apparatus 100 specifies a section for which both a work for a road and a work for an object buried in an underground of the road are planned, and executes a process for highlighting the specified section on a map. Therefore, a worker or a staff of an autonomous community can easily perform an operation for checking a section in which a schedule is to be changed.

When a work for a maintenance of a road and a work for a maintenance of an object buried in an underground of the road are planned in the same section and planned implementation dates of the respective works differ from each other, the work managing apparatus 100 performs a change of the implementation plan of the work. Thus, load of a discussion between workers and staffs of an autonomous community can be reduced, and thus a work period can be shortened. When changing the implementation plan of the work, the work managing apparatus 100 sets the implementation plan within a specific time period. Thus, an implementation time period for the work can be automatically changed in accordance with the convenience of the worker or the autonomous community.

When changing a schedule of a work, the work managing apparatus 100 informs the terminal device 10 of an order destination of the work of information on the changed schedule of the work. Thus, the change of the schedule of the work can be reliably reported to the order destination.

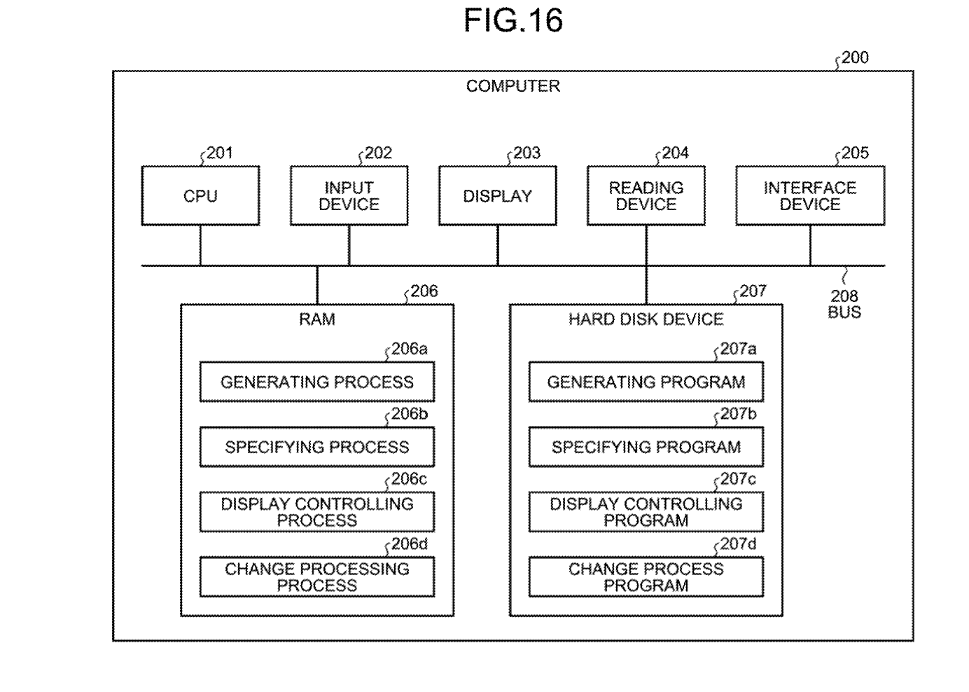

Next, one example of a computer, which executes a work managing program realizing functions similar to those of the work managing apparatus 100 described in the aforementioned embodiment, will be explained. FIG. 16 is a diagram illustrating one example of the computer that executes the work managing program.

As illustrated in FIG. 16, a computer 200 includes a CPU 201 that executes various calculation processes, an input device 202 that receives an input of data from a user, and a display 203. The computer 200 includes a reading device 204 that reads a program and the like from a memory medium, and an interface device 205 that outputs and inputs data to and from another computer through a network. The computer 200 includes a RAM 206 that temporarily memorizes various kinds of information, and a hard disk device 207. Each of the devices 201 to 207 is connected with a bus 208.

The hard disk device 207 includes a generating program 207a, a specifying program 207b, a display controlling program 207c, and a change process program 207d. The CPU 201 reads any of the generating program 207a, the specifying program 207b, the display controlling program 207c, and the change process program 207d, and expands the read program in the RAM 206. The generating program 207a functions as a generating process 206a. The specifying program 207b functions as a specifying process 206b. The display controlling program 207c functions as a display controlling process 206c. The change process program 207d functions as a change processing process 206d.

For example, the generating process 206a corresponds to the table generating unit 150b. The specifying process 206b corresponds to the specifying unit 150c. The display controlling process 206c corresponds to the display controller 150d. The change processing process 206d corresponds to the change processing unit 150e.

The generating program 207a, the specifying program 207b, the display controlling program 207c, and the change process program 207d are not needed to be preliminary memorized in the hard disk device 207. For example, each of the programs may be memorized in “portable physical medium” such as a Flexible Disk (FD), a Compact Disc Read Only Memory (CD-ROM), a Digital Versatile Disc (DVD), a magnet-optical disk, and an Integrated Circuit card (IC card), which can be inserted into the computer 200. The computer 200 may read and execute each of the programs 207a to 207d.

According to an aspect of the embodiment, a comprehensive time period for a work can be shortened.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a work managing program that causes a computer to execute a process comprising:
specifying, with reference to a memory that memorizes implementation plans of works for maintenances of a road and/or implementation plans of works for maintenances of objects buried in undergrounds of the road in association with places in which the respective works are to be implemented, a place for which both one of the works for maintenances of the road and one of the works for maintenances of objects are planned; and
displaying implementation plans of the one of the works for maintenances of the road and the one of the works for maintenances of objects buried in undergrounds of the road corresponding to the specified place so that the implementation plans of both the works are able to be distinguished from implementation plans of other works.

2. The non-transitory computer-readable recording medium according to claim 1, wherein the process includes highlighting, when the place is specified in which both the one of the works for maintenances of the road and the one of the works for maintenances of objects are planned, the specified place on a map.

3. The non-transitory computer-readable recording medium according to claim 1, wherein the works for maintenances of the road include digging up the road.

4. A non-transitory computer-readable recording medium storing a work managing program that causes a computer to execute a process comprising:
specifying, with reference to a memory that memorizes implementation plans of works for maintenances of a road and/or implementation plans of works for maintenances of objects buried in undergrounds of the road in association with places in which the respective works are to be implemented, a place for which both one of the works for maintenances of the road and one of the works for maintenances of objects are planned; and
encouraging or performing a change of at least one of implementation plans of the one of the works for maintenances of the road and the one of the works for maintenances of objects buried in undergrounds of the road corresponding to the specified place.

5. The non-transitory computer-readable recording medium according to claim 4, wherein the change includes a change of a planned implementation date.

6. The non-transitory computer-readable recording medium according to claim 4, wherein the encouraging or the performing the change includes setting, within a specific time period, the implementation plans of the one of the works for maintenances of the road and the one of the works for maintenances of objects buried in undergrounds of the road corresponding to the specified place.

7. The non-transitory computer-readable recording medium according to claim 4, wherein the performing the change includes informing a terminal device of an order destination of information on the changed implementation plan of the work.

8. The non-transitory computer-readable recording medium according to claim 4, wherein the works for maintenances of the road include digging up the road.

9. A work managing method comprising:
specifying, with reference to a memory that memorizes implementation plans of works for maintenances of a road and/or implementation plans of works for maintenances of objects buried in undergrounds of the road in association with places in which the respective works are to be implemented, a place for which both one of the works for maintenances of the road and one of the works for maintenances of objects are planned, by a processor; and
displaying implementation plans of the one of the works for maintenances of the road and the one of the works for maintenances of objects buried in undergrounds of the road corresponding to the specified place so that the implementation plans of both the works are able to be distinguished from implementation plans of other works, by the processor.

10. A work managing method comprising:
specifying, with reference to a memory that memorizes implementation plans of works for maintenances of a road and/or implementation plans of works for maintenances of objects buried in undergrounds of the road in association with places in which the respective works are to be implemented, a place for which both one of the works for maintenances of the road and one of the works for maintenances of objects are planned, by a processor; and
encouraging or performing a change of at least one of implementation plans of the one of the works for maintenances of the road and the one of the works for maintenances of objects buried in undergrounds of the road corresponding to the specified place, by the processor.

11. A work managing apparatus comprising:
a processor configured to:
specify, with reference to a memory that memorizes implementation plans of works for maintenances of a road and/or implementation plans of works for maintenances of objects buried in undergrounds of the road in association with places in which the respective works are to be implemented, a place for which both one of the works for maintenances of the road and one of the works for maintenances of objects are planned; and
display implementation plans of the one of the works for maintenances of the road and the one of the works for maintenances of objects buried in undergrounds of the road corresponding to the specified place so that the implementation plans of both the works are able to be distinguished from implementation plans of other works.

12. A work managing apparatus comprising:
a processor configured to:
specify, with reference to a memory that memorizes implementation plans of works for maintenances of a road and/or implementation plans of works for maintenances of objects buried in undergrounds of the road in association with places in which the respective works are to be implemented, a place for which both one of the works for maintenances of the road and one of the works for maintenances of objects are planned; and
encourage or perform a change of at least one of implementation plans of the one of the works for maintenances of the road and the one of the works for maintenances of objects buried in undergrounds of the road corresponding to the specified place.
